(19) United States
(12) Patent Application Publication
(10) Pub. No.: US 2007/0210745 A1
(43) Pub. Date: Sep. 13, 2007

(54) Adapter kit to replace or enhance battery configurations

(76) Inventor: Michel J. Dingeldein, Louisville, KY (US)

Correspondence Address: David W. Carrithers;CARRITHERS LAW OFFICE, PLLC, One Paragon Centre, 6060 Dutchman's Lane, Suite 140, Louisville, KY, 40205, US

(21) Appl. No.: 11/374,331

(22) Filed: Mar. 13, 2006

(51) Int. Cl. H02J 7/00

(52) U.S. Cl. 320/112

(57) ABSTRACT

A device is disclosed herein for providing AC power to a toy, flashlight, stationary device, or similar load normally powered by one or more disposable batteries. The device comprises a substitute cell adapted for insertion in the toy in place of the battery normally used. The substitute cell includes a cylindrical shell properly sized to replace the normal batteries with conductive terminals configured identically to the battery, a flexible electrical cable leading from the terminals to a power unit. The power unit comprises a power supply accepting household AC voltage and providing a DC output equal in voltage to that supplied by the batteries being replaced. In addition, this substitute shell can be opened and a charged lower sized battery can be inserted instead of using the power supply, if desired, e.g. use a C battery inserted in the device to replace a D battery. The device can accommodate a plurality of different types of battery sizes in a parallel or series arrangement.

### TECHNICAL FIELD

The present invention relates to power adaptor devices and, more particularly, to a device for providing AC power to a toy or similar load normally powered by disposable batteries.

### BACKGROUND OF THE INVENTION

As most parents will attest, children greatly enjoy playing with battery-operated toys. A great variety of such toys is available on the market, ranging from automobiles, trains, rockets and the like, to battery-powered talking dolls, animated animals, and a wide variety of games. Typically, such toys include one or more small electric motors, electric light bulbs, noise makers, or other electro mechanical devices. Other battery-operated devices include radios, phonographs and tape players.

A common feature of all these battery-operated devices, particularly those utilizing motors, is the limited lifetime of the batteries. Thus, after a few days or hours of utilization and in some instances in even less time, the batteries must be replaced. It is not unusual that over the lifetime of a toy, the cost of replacement batteries may be greater than the initial cost of the toy itself.

Several patents seek to provide power adapters or means for substituting batteries in battery packs including U.S. Pat. No. 3,586,870 by Cwiak which issued in June of 1971, U.S. Pat. No. 4,065,710 by Zytka which issued in December of 1977, U.S. Pat. No. 3,308,419 by Rohowetz et al. Which issued in March of 1967; and U.S. Pat. No. 6,208,115 by Binder which issued in March of 2001.

To eliminate the need for constantly replacing batteries, one approach of the prior art has been to provide rechargeable cells, together with an appropriate unit for recharging the cells when necessary. The disadvantage of this approach is that the number of rechargeable cells required equals the number of cells normally employed by the toys. Since rechargeable cells are relatively expensive, this approach is economically unsatisfactory.

The present invention overcomes the shortcomings of the prior art by providing a device for powering a plurality of battery-operated devices, the device accepting household AC power and providing appropriate DC voltage to the devices via substitute cells which replace directly the batteries normally used by the toys. In addition, this invention presents a solution when household power is not available and one has batteries smaller than those required in the toy or device.

### SUMMARY OF THE INVENTION

A device is disclosed herein for providing AC power to a toy, flashlight or similar load normally powered by one or more batteries. The device comprises a nonconducting substitute cell adapted for insertion in the toy in place of the battery normally used. The substitute cell includes a cylindrical shell properly sized to replace the normal batteries with conductive terminals configured identically to the battery, a flexible electrical cable leading from the terminals to a power unit. The power unit comprises a power supply accepting household AC voltage and providing a DC output equal in voltage to that supplied by the batteries being replaced. In addition, this substitute shell can be opened and a charged lower sized battery can be inserted instead of using the power supply, if desired, e.g. use a C or other selected battery inserted in the device to replace a D battery or cell of the same or even different type and/or size including AAA, AA, C and D batteries. The device can accommodate a plurality of different types of battery sizes in a parallel or series arrangement.

The present invention comprises a device for providing power to a toy or similar load normally powered by one or more batteries. The device comprises a substitute cell having a size and shape corresponding to that of a battery normally used by the toy. Terminals on the substitute cell are connected to one end of a flexible electrical cable, the other end of which terminates in an appropriate plug. Should a plurality of batteries by used one or more of the disposable batteries can be replaced by two or more substitutes as necessary, but having a direct electrical connection to the two terminals powering the toy.

The invention also includes a power unit which accepts household AC power and provides at one or more jacks a DC voltage equal to one, two, three or more batteries. In a typical embodiment, the power unit includes a power transformer, appropriate rectifier means to rectify the transformer output to DC and switching means associated with taps on the secondary of the transformer to selectively determine the output voltage provided by the power unit.

In operation, the substitute cell or cells, are inserted in the toy in place of the normally used batteries. The electrical cable from the substitute cell or cells is plugged into one of the jacks in the power unit, and the associated switch set to a position designated to correspond to the number of batteries normally used by the toy. The toy then is operable from voltage supplied by the power unit.

As shown in figures, the positive end cap can be fitted down into the hollow cell. The cap is electrically and mechanically connected, i.e. soldered) to a wire which has a jack at the opposite end to allow for connection to the positive output of the external power source (an AC powered DC power supply). The end cap is sized so that it can be pushed tightly onto the cell and will stay in place. The bottom of the cell is fitted with a negative end cap which is electrically and mechanically connected to a wire which has a jack to allow connection to the negative output of an external power source (an AC powered DC power supply). This cell can replace one battery of the same physical size and when connected to the DC power supply will then power the single celled unit through the metal end caps. If, however, the unit requires more than one battery, more cells can be installed in a series and the only end caps that need to be connected to the power unit are the positive end cap and negative end cap at the distal ends of the set of cells as shown in FIG. 14. The wires leading to the other end caps on the cells between the two distal end caps can be tucked into the battery compartment since they are dead and unnecessary. The power unit must be switched to the proper DC voltage required to power the unit.

A second and separate feature of the substitute or replacement cell is that the negative end cap on the bottom of the cell protrudes through the body of the cell with a rounded shape on top of the protrusion which comes into play when the user desires to use a fresh battery of the next smaller size to replace a battery of the normal size routinely recommended for use in the unit. The bottom of this battery, when placed inside the cell contacts the protrusion and now the cell is ready to be placed inside the device and power it. If more batteries are necessary, more cells can be used with smaller batteries in them. The positive end caps are not needed in this scenario and the negative wires may be tucked in beside the cells in the battery compartment as they are not needed to provide a connection.

Thus, it is among the primary objects of the present invention to provide a device for powering a toy or similar load normally powered by a battery.

Another object of the present invention is to provide a power supply adapted to convert household AC power to a low-level voltage and means for connecting this DC voltage to a normally battery powered device.

It is another object of the present invention to provide a substitute cell adapted to replace a battery in a toy, the substitute cell including a flexible electrical conductor for connection to the toy of an external power source.

It is an object of the invention to provide cell sleeves which correspond in the size and shape of the substitute cells such that they perfectly replace the old batteries.

A further object of the present invention is to provide in combination a substitute cell adapted to replace a battery in a toy or similar load and a power supply for providing an appropriate DC voltage to the substitute cell via electrical conductors connected to terminals of the substitute cell.

Yet another object of the present invention is to provide a power supply for supplying voltage to a device, normally operated by several batteries, with all the original cells being replaced with substitute cells where the two substitutes on each end are fitted with terminals to supply power to the toy.

Finally, another object is to allow smaller good batteries to be inserted into the substitute cells to replace or be used in combination with standard size disposable batteries.

Other objects, features, and advantages of the invention will be apparent with the following detailed description taken in conjunction with the accompanying drawings showing a preferred embodiment of the invention.

### BRIEF DESCRIPTION OF THE DRAWINGS

A better understanding of the present invention will be had upon reference to the following description in conjunction with the accompanying drawings in which like numerals refer to like parts throughout the several views and wherein:

FIG. 1 is a perspective view of an AC power supply, a DC power supply with disposable batteries, a substitute cell in the form of a hollow sleeve;

FIG. 2 is shows a negative end cap for the substitute cell;

FIG. 3 is shows a conventional AC transformer and a conventional DC power supply powered by disposable batteries.

FIG. 4 shows a smaller battery and cell sized to have an external diameter of the same size of the batter to be replaced and an inside diameter sized to hold a smaller replacement battery in position and electrical communication within the cell;

FIG. 5 shows a smaller battery disposed within the cell;

FIG. 6 shows a positive end cap for providing electrical connection between the smaller size battery in the cell and an electrical connection in communication with the original larger battery;

FIG. 7 shows a negative end cap for providing electrical connection between the smaller size battery in the cell and an electrical connection in communication with the original larger battery;

FIG. 8 is a partial phantom view showing the arrangement of the cells within the DC power unit;

FIG. 9 is an exploded view of the smaller battery and cell together with the positive end cap;

FIG. 10 is an exploded view of the smaller battery and cell together with the negative end cap;

FIG. 11 shows an exploded view of the small battery, cell and positive and negative end caps;

FIG. 12 shows a positive end cap, cell and jack for providing electrical communication between a pair of batteries in a series;

FIG. 13 shows a smaller battery sized for fitting into a cell having an outside diameter corresponding to the size of the original disposable battery to be replaced;

FIG. 14 shows a series of substitute cells; and

FIG. 15 shows cells connected in parallel.

### DESCRIPTION OF THE PREFERRED EMBODIMENTS

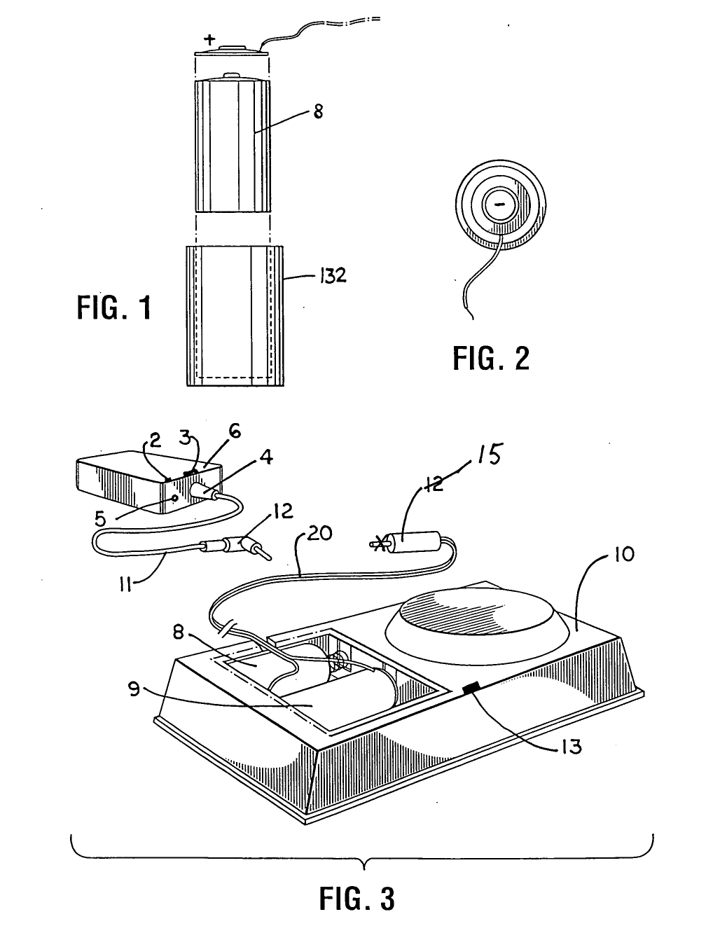

In accordance with the present invention, there is provided a device for supplying power to a toy, stationary device, or similar load which normally is powered by one or more batteries. By way of example, as shown in FIGS. 1-4, the invention includes a power unit 10 normally powered by disposable batteries 8 and 9 adapted to receive household AC voltage via line cord 11 and plug 12. The power unit is turned ON and OFF by means of switch 13.

An alternate power unit 6 may be used substituted or used in combination with the disposable battery powered power unit 10 for the preferred embodiment shown in FIG. 1 that is capable of providing power independently to two loads, via a first jack 4 and a second jack 5. The voltage level available at a first jack can be controlled by a first selector switch 3, while the voltage level available at a second jack can be controlled by a second selector switch 2. The first and second switches can be of the multi position variety, the positions being designated by numbers which may correspond to the number of batteries normally utilized by the load being powered by power unit 10.

Devices which normally are powered by disposable or rechargeable batteries may be powered by the present invention to save batteries or utilize the battery powered device with dead batteries as a power replacement means. For example, toy automobiles such as those manufactured by HOT WHEELS, can be powered by placing the vehicle between two rubber rollers spaced apart in alignment with one another so insertion of a coaster car in between the spinning rollers accelerates the car. A battery pack 14 utilizing disposable D batteries normally powers the rotating rollers. In accordance with the present invention, these batteries have been replaced by appropriate substitute dummy cells, to be described in detail herein below, and provided with a two-conductor flexible lead 20 terminating in a plug 12 in electrical communication with the AC power source 6 in order to provide an AC power source to standard disposable batteries.

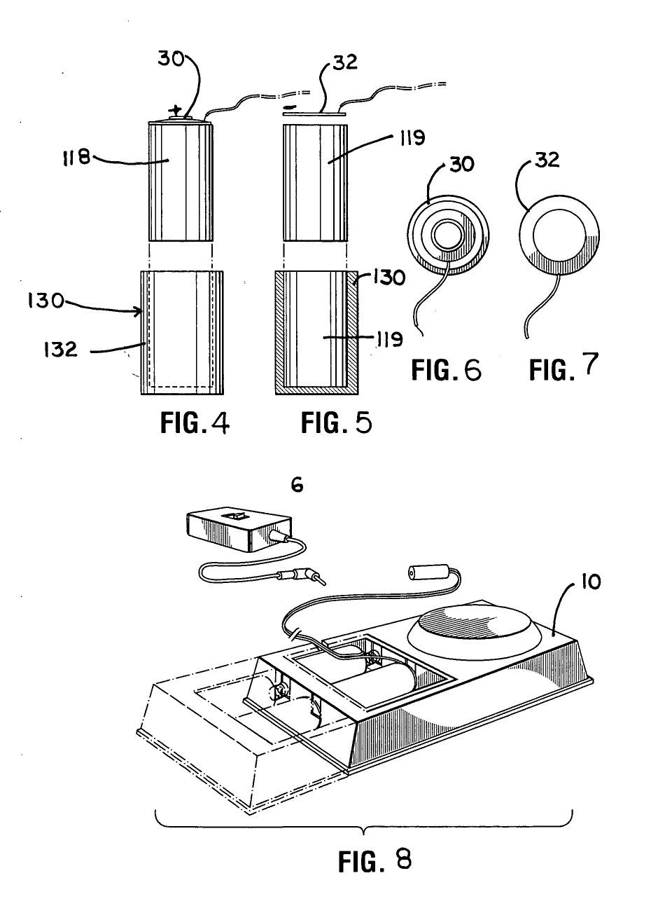

More particularly as shown in FIGS. 4-8, a typical substitute cell kit includes an upper cap 30 which fist onto the body of a selected cell 8. The upper cap 30 is metallic and serves as the positive connection to the device to be powered by the substitute cell or cells 130. It is fitted with a wire which has a jack at the opposite end to allow connect to the positive output of the external AC powered DC supply with a selectable voltage output necessary to power the disposable battery powered device 10. The body 132 of the substitute cell 130 has a metallic cap 32 at the bottom end of the cell which serves as the negative connection to the negative output of the external DC supply.

Devices normally powered by one or more disposable batteries contained within the battered powered power source or even an alternate power source can be replaced with substitute and dummy cells in accordance with the present invention, power thereby being provided to the control unit via a flexible lead and plug.

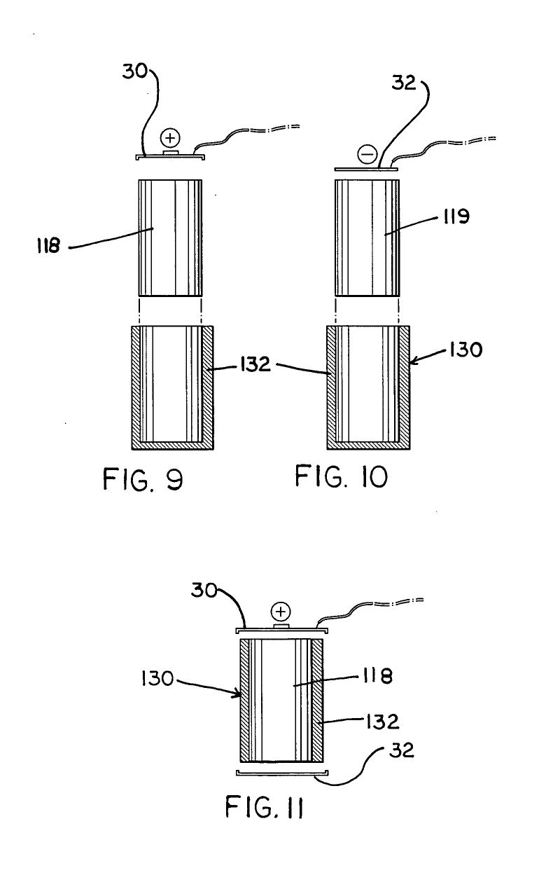

A substitute cell 130 for a conventional D size battery is shown in FIGS. 4-11, wherein a battery of a smaller size, for example a C size battery 118 and 119 is inserted within the cell 130 and the cell 130 functions as a selectable sizing sleeve. The cap 32 on the bottom of the cell 130 protrudes into the cell 130 and makes electrical contact with the fresh smaller battery 118 or 119 inside the cell 130 when one desires to power the device with one or more of the smaller cells 118, 119 instead of the DC supply if not available.

The power unit 10 is conventional in that it includes a transformer having a primary winding adapted to receive household AC voltage, typically 110 volts at 60 cycles, supplied via conductors. An on-off switch is connected in series with primary winding. One end of the secondary winding of the transformer is connected via a fuse to the anode of a first diode and to the cathode of a second diode. The cathode of diode is connected to the positive terminal of a jack. The anode of the diode is connected to the negative terminal of the jack. The negative terminal of jack is connected to the rotary contact of a selector switch. The positive contact of the jack is connected to the rotary contact of switch.

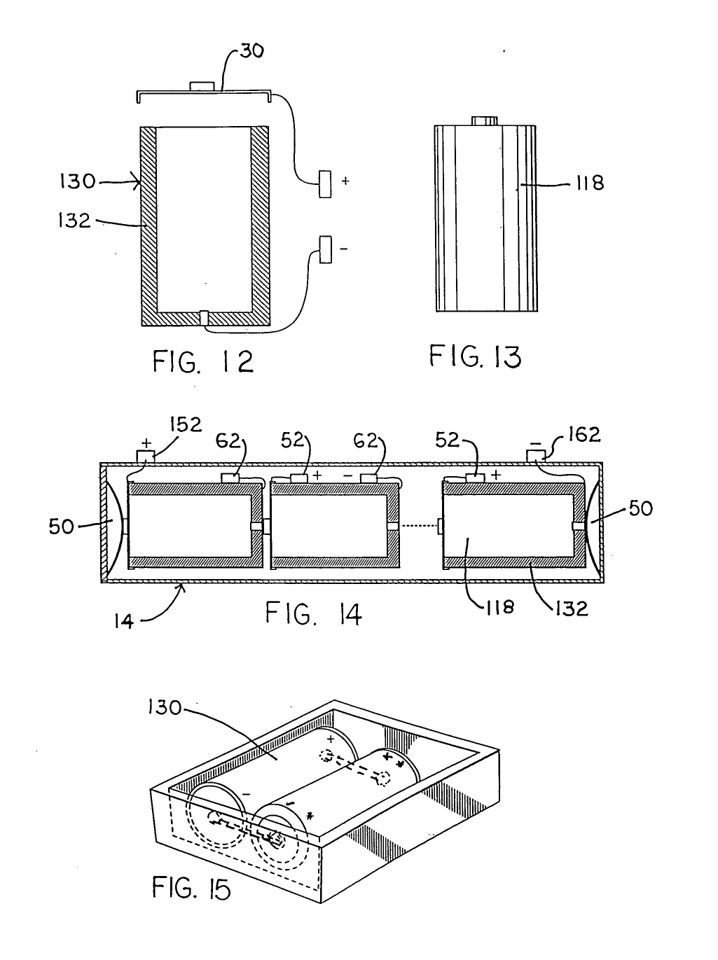

FIGS. 12-15 show a typical arrangement of multiple cells used to power a device having at least two batteries in parallel or a series arrangement. As shown in FIG. 14, the only lead needed to supply power to the device are is the lead at each end of the cell set wherein the positive lead or tap 152 and the negative lead or tap 162. All of the other positive leads 52 and negative leads 62 disposed therein between and jacks can be tucked in beside the cells 130. Preferably the jacks are insulated to avoid be shorted out within the case or battery holding device. The metallic caps to which the leads are connected are in contact with and supply power to the device. If the user does not want to use the external DC supply, but has the next small size batteries, none of the leads are used and all of the leads can be tucked into the cells so that fresh smaller substitute batteries can be used with the device.

Preferably, taps 152 and 162 are appropriately selected so as to provide at voltages substantially equal to that provided by one, two, three or four of the batteries being replaced by the inventive power unit.

Referring once again to FIGS. 1-15, the load represents the electrical load portion of a typical item to be powered by one or more batteries. To operate the load from power unit 10, the battery normally powering the load is replaced by a substitute cell 130 of the type described above having an associated flexible lead terminating in a plug. The plug is inserted into a selected jack and the corresponding selector switch is set at selected position to provide a voltage to the load is equal to the voltage provided by a selected number of cells. Of course, the polarity of the voltage supplied to load will correspond to that supplied by the cell being replaced, since the tip of the plug which is electrically connected to the positive terminal of substitute cell 130 contacts the positive terminal.

It will be appreciated that various changes or modifications to the present invention may be made without departing from the spirit and scope thereof. For example, while power unit 6 has been illustrated as including switches to permit selection of the voltage available at the output terminals, this is not required. For example, power unit 6 may be adapted only to provide the voltage equal to, say, three cells, rather than to provide selectable voltages. Alternatively, separate jacks may be provided for each available voltage level. In this instance, the plug from the substitute cell would be inserted into that jack supplying the voltage level required by the device being powered. Alternatively, other electrical circuitry may be provided in power unit 10 to supply the necessary voltage. For example, a transformer having an untapped secondary winding may be used and an appropriate resistor divider network employed to provide the requisite voltage levels. Then too, other types of connectors, for example, screw-type terminals, could be used in place of plugs and jacks.

The foregoing detailed description is given primarily for clearness of understanding and no unnecessary limitations are to be understood therefrom, for modifications will become obvious to those skilled in the art based upon more recent disclosures and may be made without departing from the spirit of the invention and scope of the appended claims.

1. An adapter kit for providing power to a device utilizing at least one replaceable battery of a first size comprising:
at least one longitudinally yieldable substitute cell adapted for insertion in said device in place of said at least one replaceable battery;
a said substitute cell selected to correspond to the size and shape of said replaceable battery;
said substitute cell having a longitudinal bore for holding a second charged battery of a selected smaller size for powering said device when a replacement battery of the same size is unavailable;
said substitute cell including conductive terminals defining end walls of said cell and providing electrical communication with said device in the same manner as the terminals of said replaceable battery;
a two-conductor flexible lead carried along side said cell within said device, one end of each conductor being connected to a corresponding one of said conductive terminals; and
power unit means for providing to the other end of said conductors a DC voltage corresponding in level to that normally provided by said batteries.

2. The adapter kit defined in claim 1 wherein said power unit means comprises a transformer having a primary winding adapted to receive household AC voltage, a secondary winding and rectifying means adapted to provide voltages commensurate with those required to operate said load device;

3. The device of claim 1, wherein said substitute cells has an exterior size and shape corresponding to said at least one replaceable battery and said longitudinal bore defining an interior size and shape corresponding to said replacement battery.

4. The device of claim 1, wherein said at least one second charged battery is the next smaller size.

5. The adapter kit of claim 1, wherein said at least one replaceable battery of the first size is a ‘D’ size battery and said second charged battery of a selected smaller size for powering said device when a replacement battery of the same size is unavailable is size ‘C’.

6. The adapter kit of claim 1, wherein said at least one replaceable battery of the first size is a ‘C’ size battery and said second charged battery of a selected smaller size for powering said device when a replacement battery of the same size is unavailable is size ‘AA’.

7. The adapter kit of claim 1, wherein said at least one replaceable battery of the first size is a ‘AA’ size battery and said second charged battery of a selected smaller size for powering said device when a replacement battery of the same size is unavailable is size ‘AAA’.

8. An adapter kit for providing power to a device utilizing at least one replaceable battery of a first size comprising:
at least one longitudinally yieldable substitute cell adapted for insertion in said device in place of said at least one replaceable battery;
a said substitute cell selected to correspond to the size and shape of said replaceable battery;
said substitute cell including conductive terminals defining end walls of said cell and providing electrical communication with said device;
a two-conductor flexible lead carried along side said cell within said device, one end of each conductor being connected to a corresponding one of said conductive terminals; and
power unit means for providing to the other end of said conductors a DC voltage corresponding in level to that normally provided by said batteries.

9. A battery conversion device for providing power to a device utilizing at least one replaceable battery of a first size comprising:
at least one longitudinally yieldable substitute cell adapted for insertion in said device in place of said at least one replaceable battery;
a said substitute cell selected to correspond to the size and shape of said replaceable battery;
said substitute cell having a longitudinal bore for holding a second charged battery of a selected smaller size for powering said device when a replacement battery of the same size is unavailable; and
said substitute cell including conductive terminals defining end walls of said cell and providing electrical communication with said device.

10. The battery conversion device of claim 1, wherein said at least one replaceable battery of the first size is a ‘D’ size battery and said second charged battery of a selected smaller size for powering said device when a replacement battery of the same size is unavailable is size ‘C’.

11. The battery conversion device of claim 1, wherein said at least one replaceable battery of the first size is a ‘C’ size battery and said second charged battery of a selected smaller size for powering said device when a replacement battery of the same size is unavailable is size ‘AA’.

12. The battery conversion device of claim 1, wherein said at least one replaceable battery of the first size is a ‘AA’ size battery and said second charged battery of a selected smaller size for powering said device when a replacement battery of the same size is unavailable is size ‘AAA’.
